(19) United States
(12) Patent Application Publication
(10) Pub. No.: US 2002/0107296 A1
(43) Pub. Date: Aug. 8, 2002

(54) Non-silicone foaming additive for ester based lubricants

(76) Inventor: Nicholas E. Schnur, Cincinnati, OH (US)

Correspondence Address: COGNIS CORPORATION, 2500 RENAISSANCE BLVD., SUITE 200, GULPH MILLS, PA, 19406

(21) Appl. No.: 09/947,326

(22) Filed: Sep. 5, 2001

Related U.S. Application Data
(60) Provisional application No. 60/237,837, filed on Oct. 3, 2000.

(51) Int. Cl. C08G 63/00; C09K 3/00

(52) U.S. Cl. 521/182; 516/12

(57) ABSTRACT

Functionalized perfluoropolyethers are used as foam generating additives with ester-based lubricants in combination with chlorine-free hydrofluorocarbon refrigerants.

### CROSS-REFERENCE TO RELATED APPLICATIONS

This application claims the benefit of copending provisional application serial No. 60/237,837, filed on Oct. 3, 2000, the entire contents of which are incorporated herein by reference.

### BACKGROUND OF THE INVENTION

The use of lubricants that foam are at times used in refrigeration compressors to reduce noise. Since most polyol ester-based refrigerant lubricants do not foam, foaming additives must be incorporated into these lubricants. The foam-producing additives universally used in these applications are based on silicone. A major drawback to the use of silicone-based foaming additives is that they can cause capillary tube plugging in the refrigeration compressor. Thus, there is a need in the refrigeration industry for a non-silicone foaming lubricant additive.

### BRIEF SUMMARY OF THE INVENTION

One aspect of the present invention pertains to the use of a functionalized perfluoropolyether as a foam generating additive for use with ester-based refrigerant lubricants. One aspect of the present invention pertains to a composition comprised of a carboxylic acid ester and a foam generating amount of a functionalized perfluoropolyether.

Another aspect of the present invention pertains to a method of creating foam or increasing the amount of foam in a carboxylic acid ester which comprises adding a foam generating effective amount of a functionalized perfluoropolyether to a carboxylic acid ester.

Yet another aspect of the present invention pertains to a refrigerant compressor used in a refrigeration cycle. The refrigerant compressor comprises a high-pressure closed vessel stored with a refrigeration lubricant which is comprised of a carboxylic acid ester and a functionalized perfluoropolyether. The closed vessel accommodates a motor composed of a rotor and a stator having a winding wire and an insulating film, a rotating shaft fitted in the rotor, and a compressor section connected to the motor through the rotating shaft, and in which a high-pressure refrigerant gas discharged from the compressor section resides.

The functionalized perfluoropolyethers according to the invention do not cause capillary tube plugging in the refrigeration compressor.

### BRIEF DESCRIPTION OF THE SEVERAL VIEWS OF THE DRAWINGS

Not applicable.

### DETAILED DESCRIPTION OF THE INVENTION

The foam generating additive according to the invention is a functionalized perfluoropolyether and is described in U.S. Pat. Nos. 6,156,937 and 6,191,314 B1, the entire contents of each of which is incorporated herein by reference. A preferred functionalized perfluoropolyether is FLUOROLINK® 7007, a trademark product of Ausimont S.p.A, Italy, described as 1-propene, 1,1,2,3,3,3-hexafluoro-, telomer with chlorotrifluoroethene, oxidized, reduced Et esters, reaction products with 3-(triethoxysilyl)-1-propanamine and having a CAS number of 223557-62-8.

As used herein, the term carboxylic acid ester means any type of ester of a mono- or polycarboxylic acid having from one to about 36 carbon atoms and a monool or a polyol. A polycarboxylic acid is one having two or more carboxyl groups. A monool is an alcohol having one OH group and a polyol is an alcohol having two or more OH groups. In a preferred embodiment of the invention, the foaming additive according to the invention is used to generate foam in a polyol ester of a mono carboxylic acid such as, for example, a pentaerythritol ester of a mixture of linear and branched C₅ and C₉ mono carboxylic acids. Such esters are typically used as lubricants with chlorine-free hydrofluorocarbon refrigerants. The amount of functionalized perfluoropolyether that can be used in the compositions and processes according to the invention is a foam generating effective amount which is any amount required to generate a desired or necessary amount of foam in a particular type of carboxylic acid ester. A foam generating effective amount will depend upon such things as the amount of foam required to be generated, the nature of the carboxylic acid ester, conditions under which the foam must be generated, the noise level reduction sought, and the like and will be readily determinable by one of ordinary skill in the art. Typically, the foam generating effective amount will be from about 0.001% by weight to about 1% by weight of the carboxylic acid ester. The preferred amount is 0.01%.

The functionalized perfluoropolyether foam additive does not affect refrigerant miscibility and products formulated with it pass the Sealed Tube Stability Test as shown in the Examples below.

Another aspect of the present invention pertains to a refrigerant compressor used in a refrigeration cycle. The refrigerant compressor comprises a high-pressure closed vessel stored with a refrigeration lubricant which is comprised of a carboxylic acid ester and a functionalized perfluoropolyether. The closed vessel accommodates a motor composed of a rotor and a stator having a winding wire and an insulating film, a rotating shaft fitted in the rotor, and a compressor section connected to the motor through the rotating shaft, and in which a high-pressure refrigerant gas discharged from the compressor section resides. A typical refrigerant compressor is described in U.S. Pat. No. 5,964,581, the entire contents of which are incorporated herein by reference.

The following example is meant to illustrate but not to limit the invention.

### EXAMPLE

The data set forth in the table below shows the foam generating effect of the addition of various amounts of the functionalized perfluoropolyether according to the invention to a typical polyol ester refrigerant lubricant. The presence of the functionalized perfluoropolyether had no adverse effect on the sealed tube stability and on the miscibility of the ester and refrigerant. The POE without the functionalized perfluoropolyether exhibited no foam in the foam test. The amounts of the components in the table are expressed in wt %.

| COMPONENT | 1 | 2 | 3 | 4 |
|---|---|---|---|---|
| POE¹ | 99.9 | 99.5 | 99.99 | 98.14 |
| PFPE² | 0.1 | 0.5 | 0.01 | 0.01 |
| Anti-wears³ | — | — | — | 1.75 |
| BHT⁴ | — | — | - | 0.10 |
| FOAM⁵ | 190 | 300 | 180 | 170 |
| Stability⁶ | Good | Good | Good | Good |
| Miscibility⁷ | <−70° F. | <−70° F. | <−70° F. | <−70° F. |

¹Pentaerythritol ester of a mixture of C-5 and C-9 mono-carboxylic acids
²FLUOROLINK ® 7007 Perfluoropolyether
³Phosphate anti-wear additive
⁴Butylated hydroxy toluene
⁵Foam Test - ASTM D-892 Sequence #1
⁶Sealed tube stability- ASHRAE 97-1983, Al, Cu, mild steel, 14 days @ 175° C.
⁷Miscibility with 90% R134a refrigerant + 10% Pentaerythritol ester of a mixture of C-5 and C-9 mono-carboxylic acids

What is claimed is:

1. A composition comprising a carboxylic acid ester and a functionalized perfluoropolyether.

2. The composition of claim 1 wherein the carboxylic acid ester is a polyol ester.

3. The composition of claim 2 wherein the polyol ester is a pentaerythritol ester of a mixture of linear and branched C₅ and C₉ mono carboxylic acids.

4. The composition of claim 1 wherein the amount of the functionalized perfluoropolyether is a foam generating effective amount.

5. The composition of claim 1 wherein the effective amount is from about 0.001% to about 1% by weight of the carboxylic acid ester.

6. The composition of claim 5 wherein the foam generating effective amount is from about 0.001% to about 0.1% by weight of the carboxylic acid ester.

7. A composition comprising a pentaerythritol ester of a mixture of linear and branched C₅ and C₉ mono carboxylic acids and a functionalized perfluoropolyether.

8. A composition comprising a pentaerythritol ester of a mixture of linear and branched C₅ and C₉ mono carboxylic acids and a foam generating effective amount of a functionalized perfluoropolyether.

9. A composition comprising a pentaerythritol ester of a mixture of linear and branched C₅ and C₉ mono carboxylic acids and from about 0.001% to about 0.1% by weight of a functionalized perfluoropolyether.

10. A method of increasing or generating foam in a carboxylic acid ester comprising adding to the carboxylic acid ester a foam generating effective amount of a functionalized perfluoropolyether.

11. The method of claim 10 wherein the carboxylic acid ester is a polyol ester.

12. The method of claim 11 wherein the polyol ester is a pentaerythritol ester of a mixture of linear and branched C₅ and C₉ mono carboxylic acids.

13. The method of claim 11 wherein the foam generating effective amount is from about 0.001% to about 1% by weight of the carboxylic acid ester.

14. The method of claim 13 wherein the foam generating effective amount is from about 0.001% to about 0.1% by weight of the carboxylic acid ester.

15. A refrigerant compressor used in a refrigeration cycle wherein the refrigerant compressor comprises a high-pressure closed vessel stored with a refrigeration lubricant which is comprised of a carboxylic acid ester and a foam generating effective amount of functionalized perfluoropolyether and wherein the closed vessel accommodates a motor comprised of a rotor and a stator having a winding wire and an insulating film, a rotating shaft fitted in the rotor, and a compressor section connected to the motor through the rotating shaft, and in which a high-pressure refrigerant gas discharged from the compressor section resides.

16. The refrigerant compressor of claim 15 wherein the carboxylic acid ester is a polyol ester.

17. The refrigerant compressor of claim 16 wherein the polyol ester is a pentaerythritol ester of a mixture of linear and branched C₅ and C₉ mono carboxylic acids.

18. The refrigerant compressor of claim 15 wherein the foam generating effective amount is from about 0.001% to about 1% by weight of the carboxylic acid ester.

19. The refrigerant compressor of claim 18 wherein the foam generating effective amount is from about 0.001% to about 0.1% by weight of the carboxylic acid ester.
